(19) United States
(12) Patent Application Publication
(10) Pub. No.: US 2003/0193523 A1
(43) Pub. Date: Oct. 16, 2003

(54) Ebook reading timer

(76) Inventor: Carolynn Rae Johnson, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/119,578

(22) Filed: Apr. 10, 2002

(51) Int. Cl. G09G 5/00

(52) U.S. Cl. 345/772

(57) ABSTRACT

An Ebook includes a memory device, a reading timer, and a display. The memory device stores files. The files include text. The reading timer performs timer functions. The display displays the text. The display further displays a visual alarm when either of a current time is equal to a pre-specified time or a pre-specified amount of time has expired.

### BACKGROUND OF THE INVENTION

1. Field of the Invention

The present invention generally relates to electronic books (Ebooks) and, more particularly, to an Ebook reading timer.

2. Background of the Invention

An electronic book (also referred to as an “Ebook”) is an electronic version of a traditional print book (or other printed material such as, for example, a magazine, newspaper, and so forth) that can be read by using a personal computer or by using an Ebook reader.

Individuals who read a great deal often find themselves becoming deeply involved in the reading material to the extent that they suffer a loss of situational awareness and lose track of time. The reader who has only a limited amount of time to read finds himself forced to constantly interrupt his or her reading to glance at a clock/watch or risk reading for too long. Thus, the reading experience of the reader is made less pleasant.

Accordingly, it would be desirable and highly advantageous to have an Ebook that includes a way to automatically inform a user that a pre-specified time has arrived or that a pre-specified amount of time has expired so that an Ebook user having a limited amount of time to read can partake in reading without the need to monitor the time.

### SUMMARY OF THE INVENTION

The problems stated above, as well as other related problems of the prior art, are solved by the present invention, an Ebook having a reading timer and a method for using an Ebook having a reading timer.

According to an aspect of the present invention, there is provided an Ebook that includes a memory device, a reading timer, and a display. The memory device stores files. The files include text. The reading timer performs timer functions. The display displays the text. The display further displays a visual alarm when either of a current time is equal to a pre-specified time or a pre-specified amount of time has expired.

According to another aspect of the present invention, there is provided a method for using an Ebook. At least one file is stored in the Ebook. The at least one file includes text. A first input is received that specifies a specific time or a specific amount of time. The text is displayed. A visual alarm is displayed and/or an audible alarm is sounded, when a current time equals the specific time or the specific amount of time has expired.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a computer system 100 to which the present invention may be applied, according to an illustrative embodiment of the present invention;

FIG. 2 is a block diagram illustrating an Ebook 200, according to an illustrative embodiment of the present invention;

FIG. 3 is a flow diagram illustrating a method for using an Ebook having a reading timer, according to an illustrative embodiment of the present invention;

FIG. 4 is a diagram illustrating a menu corresponding to step 315 of the method of FIG. 3, according to an illustrative embodiment of the present invention; and

FIG. 5 is a diagram illustrating a menu corresponding to steps 340 through 355 of the method of FIG. 3, according to an illustrative embodiment of the present invention.

### DETAILED DESCRIPTION OF THE INVENTION

The present invention is directed to an Ebook having a reading timer and a method for using an Ebook having a reading timer.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

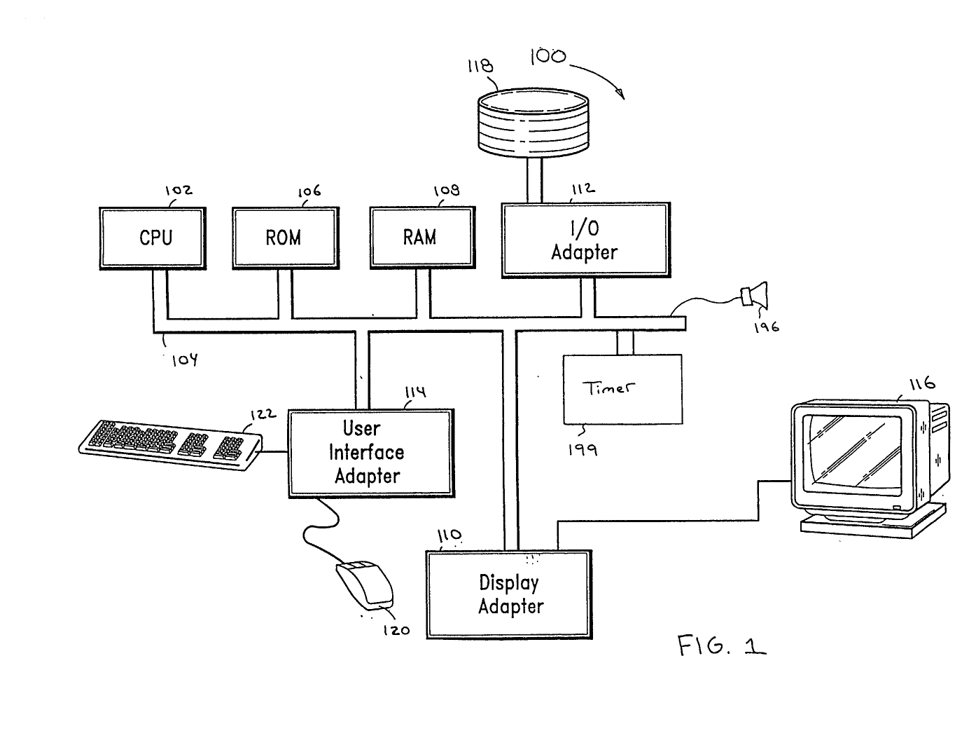

FIG. 1 is a block diagram illustrating a computer system 100 to which the present invention may be applied, according to an illustrative embodiment of the present invention. The computer processing system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

The computer system 100 further includes a speaker 196 and a timer 199.

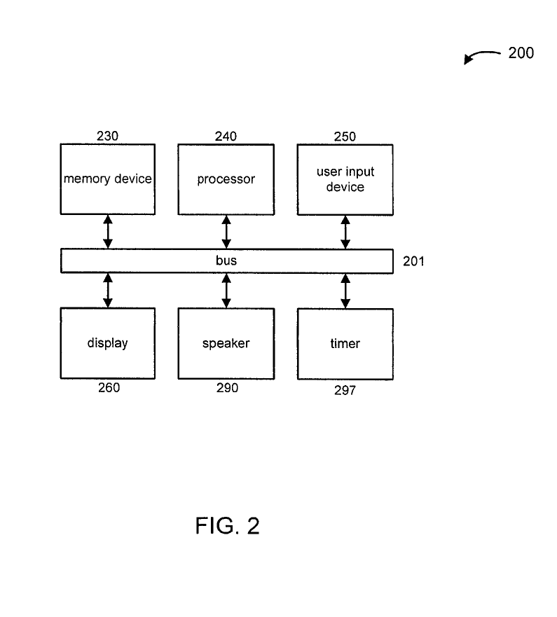

FIG. 2 is a block diagram illustrating an Ebook 200, according to an illustrative embodiment of the present invention. The Ebook 200 includes the following elements interconnected by bus 201: at least one memory device (hereinafter “memory device” 230); at least one processor (hereinafter “processor” 240); a user input device 250 (e.g., keyboard, keypad, and/or remote control); a display 260; a speaker 290; and a timer 297. Given the teachings of the present invention provided herein, one of ordinary skill in the related art will contemplate these and various other configurations of the computer system 100 and Ebook 200 respectively shown in FIGS. 1 and 2, while maintaining the spirit and scope of the present invention. It is to be appreciated that as used herein the term “Ebook” refers to either a standalone Ebook device (e.g., Ebook 200) or an Ebook included in a computer system (e.g., computer system 100).

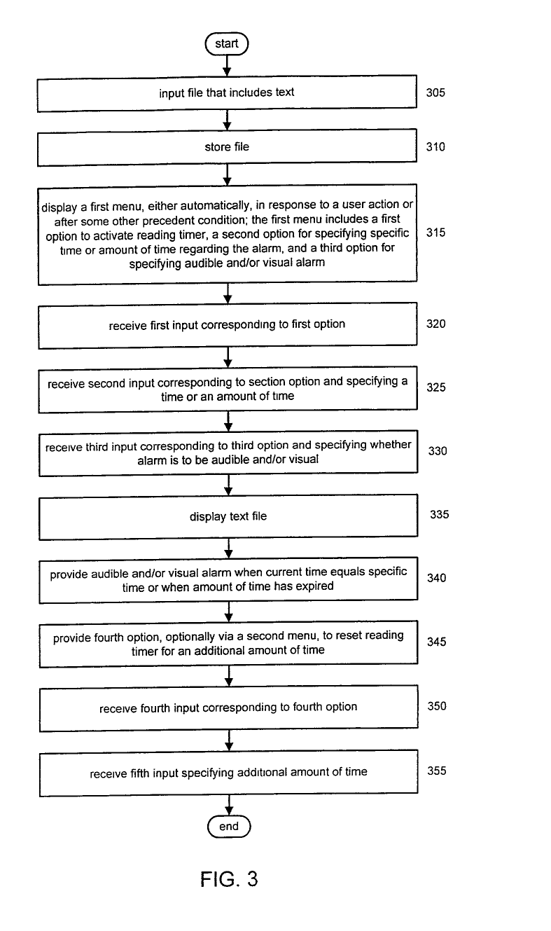

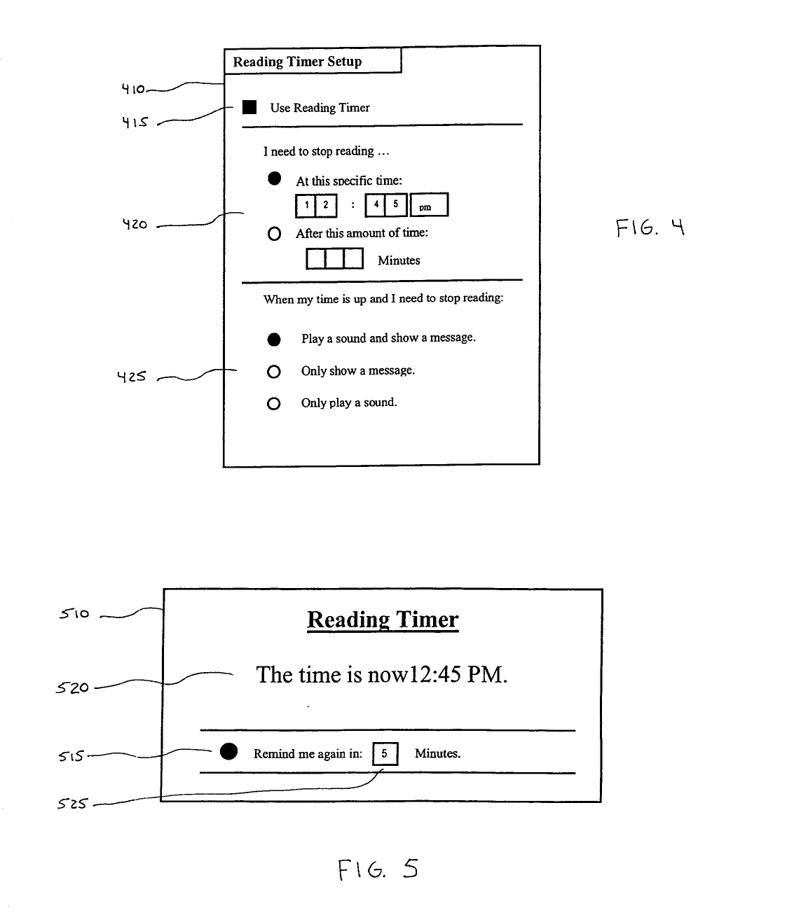

FIG. 3 is a flow diagram illustrating a method for using an Ebook having a reading timer, according to an illustrative embodiment of the present invention. FIG. 4 is a diagram illustrating a menu corresponding to step 315 of the method of FIG. 3, according to an illustrative embodiment of the present invention. FIG. 5 is a diagram illustrating a menu corresponding to steps 340 through 355 of the method of FIG. 3, according to an illustrative embodiment of the present invention.

One or more files (hereinafter “file”) are input into the Ebook (step 305). The file includes, at the least, text. The file may be provided via a memory device (e.g., floppy disk, compact disk, flash memory, and so forth), downloaded from the Internet, and so forth. The file may be an Ebook application file, an e-mail file, a Web page, a word processor document, and so forth. The file is then stored in the Ebook (step 310). Steps 305 and 310 may be performed at any time and need not be performed “immediately” prior to the remaining steps of the method of FIG. 3. For example, steps 305 and 310 may be performed hours, days, weeks, months, and so forth, prior to the remaining steps of the method of FIG. 3.

Subsequent to steps 305 and 310, a first menu 410 is displayed corresponding to the reading timer (step 315). The first menu 410 may be provided at any time, either automatically, in response to a user action, or after some other precedent condition. Preferably, the first menu 410 is provided to an Ebook user each time the Ebook is powered up.

The first menu includes a first option 415, a second option 420, and a third option 425. The first option 415 allows the Ebook user to activate the reading timer. The second option 420 allows the Ebook user to either specify a specific time at which an alarm is to be provided or to specify an amount of time upon the expiration of which the alarm will be provided. The third option 425 allows the Ebook user to specify whether the alarm is to be audible and/or visual. It is to be appreciated that the terms “alarm” and “alert” are used interchangeably herein.

A first input is received corresponding to the first option 415 to activate the reading timer (step 320). A second input is received corresponding to the second option 420 and specifying a time (e.g., 12:45 PM) or an amount of time (30 minutes) (step 325). A third input is received corresponding to the third option 425 and specifying whether the alarm is to be audible and/or visual (step 330).

The text included in the file is then displayed on a display (step 335). An audible and/or a visual alert, as specified at step 330, are/is provided when the current time equals the specific time specified at step 325 or when the amount of time specified at step 325 has expired (step 340).

Subsequent to, or concurrent with, providing the audible and/or visual alert at step 340, a fourth option is provided to reset the reading timer for an additional amount of time (step 345).

According to one illustrative embodiment shown in FIG. 5, the fourth option 515 is provided to the Ebook user via another menu 510 that includes the visual alarm 520 (when the visual alarm is specified at step 330) and that allows the user to select the fourth option 515 and to specify the additional amount of time 525 corresponding to the fourth option.

A fourth input is received corresponding to acceptance of the fourth option provided at step 345 to reset the time period for the additional amount of time (step 350). The additional amount of time may be preset (by the Ebook user or by the factory) or may be entered by the Ebook user. In the latter case, a fifth input is received specifying the additional amount of time (step 355).

Although the illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. An Ebook, comprising:
a memory device for storing files, the files including text;
a reading timer for performing timer functions; and
a display for displaying the text,
wherein said display further displays a visual alarm when either of a current time is equal to a pre-specified time or a pre-specified amount of time has expired.

2. The Ebook of claim 1, wherein said display displays the visual alarm only when a specific request for the visual alarm has been previously received and either of the current time equals the pre-specified time or the pre-specified -amount of time has expired.

3. The Ebook of claim 1, further comprising at least one speaker for sounding an audible alarm either in place of or in conjunction with the visual alarm, when either of the current time equals the pre-specified time or the pre-specified amount of time has expired.

4. The Ebook of claim 3, wherein said at least one speaker sounds the audible alarm only when a specific request for the audible alarm has been previously received and either of the current time equals the pre-specified time or the pre-specified amount of time has expired.

5. The Ebook of claim 1, wherein said display further displays a menu that includes an option to activate said reading timer.

6. The Ebook of claim 1, wherein said display further displays a menu that includes an option to specify at least one of the pre-specified time or the pre-specified amount of time.

7. The Ebook of claim 1, wherein said display further displays a menu that includes an option to reset said reading timer for an additional amount of time, upon the current time being equal to the pre-specified time or the pre-specified amount of time having expired.

8. The Ebook of claim 7, wherein the menu further includes an input box for specifying the additional amount of time.

9. The Ebook of claim 7, wherein the visual alarm is provided as part of the menu.

10. An Ebook, comprising:
a memory device for storing files, the files including text;
a reading timer for performing timer functions;
a display for displaying the text; and
at least one speaker for sounding an audible alarm when either of a current time equals a pre-specified time or a pre-specified amount of time has expired.

11. The Ebook of claim 10, wherein said at least one speaker sounds the audible alarm only when a specific request for the audible alarm has been previously received and either of the current time equals the pre-specified time or the pre-specified amount of time has expired.

12. The Ebook of claim 10, wherein said display further displays a visual alarm either in place of or in conjunction with the visual alarm, when either of the current time is equal to the pre-specified time or when the pre-specified amount of time has expired.

13. The Ebook of claim 12, wherein said display displays the visual alarm only when a specific request for the visual alarm has been previously received and either of the current time equals the pre-specified time or the pre-specified amount of time has expired.

14. The Ebook of claim 10, wherein said display further displays a menu that includes an option to activate said reading timer.

15. The Ebook of claim 10, wherein said display further displays a menu that includes an option to specify at least one of the pre-specified time or the pre-specified amount of time.

16. The Ebook of claim 10, wherein said display further displays a menu that includes an option to reset said reading timer for an additional amount of time, upon the current time being equal to the pre-specified time or the pre-specified amount of time having expired.

17. The Ebook of claim 16, wherein the menu further includes an input box for specifying the additional amount of time.

18. A method for using an Ebook, comprising the step of:
storing at least one file in the Ebook, the at least one file including text;
receiving a first input specifying a specific time or a specific amount of time;
displaying the text;
providing an alarm, when a current time equals the specific time or the specific amount of time has expired.

19. The method of claim 18, wherein said providing step comprises the step of at least one of displaying a visual alarm and sounding an audible alarm.

20. The method of claim 19, wherein the visual alarm is displayed only when a specific request for the visual alarm has been previously received and either of the current time equals the specific time or the specific amount of time has expired.

21. The method of claim 19, wherein the audible alarm is sounded only when a specific request for the audible alarm has been previously received and either of the current time equals the specific time or the specific amount of time has expired. 12

22. The method of claim 18, wherein said Ebook includes a reading timer, and said method further comprises the step of displaying a menu that includes an option to activate the reading timer for performing timer functions with respect to the specific time or the specific amount of time.

23. The method of claim 18, further comprising the step of displaying a menu that includes an option to specify at least one of the pre-specified time or the specific amount of time.

24. The method of claim 18, further comprising the step of displaying a menu that includes an option to reset the reading timer for an additional amount of time, upon the current time being equal to the pre-specified time or the specific amount of time having expired.

25. The method of claim 24, wherein the menu further includes an input box for specifying the additional amount of time.

26. The Ebook of claim 24, wherein the visual alarm is provided as part of the menu.
